(19) United States
(12) Patent Application Publication
(10) Pub. No.: US 2026/0093945 A1
(43) Pub. Date: Apr. 2, 2026

(54) Adaptive Media Processing Command Handling in Radiofrequency-Enabled Printers

(71) Applicant: Zebra Technologies Corporation, Lincolnshire, IL (US)

(72) Inventors: Blake E. Nemura, Saint Charles, IL (US); Chris H. Robertson, Oark, AR (US); Scott R. Prentice, Bloomingdale, IL (US)

(73) Assignee: Zebra Technologies Corporation, Lincolnshire, IL (US)

(21) Appl. No.: 18/984,750

(22) Filed: Dec. 17, 2024

Related U.S. Application Data
(60) Provisional application No. 63/700,490, filed on Sep. 27, 2024.

(51) Int. Cl. G06K 15/00; G06K 15/02

(52) U.S. Cl. CPC G06K 15/408; G06K 15/024

(57) ABSTRACT

A method in a media processing device includes: determining an attribute of a radiofrequency (RF) tag associated with a media supply; receiving a command to write first data to the RF tag; determining whether the first data and the RF tag are compatible based on the attribute; when the first data and the RF tag are incompatible, modifying the first data to generate modified data compatible with the RF tag based on the attribute; and writing the modified data to the RF tag.

### CROSS-REFERENCE TO RELATED APPLICATIONS

This application claims priority from U.S. provisional patent application no. 63/700490 filed on September 27, 2024, the contents of which is incorporated herein by reference.

### BACKGROUND

Labels and other media can include embedded radiofrequency (RF) tags, e.g., to store identifiers of items the labels are affixed to. The labels can also bear graphical indicia, such as barcodes, text, or the like. If an operation to write data to an RF tag embedded in a label fails, e.g., due to incompatibility between the RF tag and the data, the label may be discarded, e.g., with the graphical indicia being omitted or the like.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a media processing device.

FIG. 2 is a cross section of the media processing device of FIG. 1.

FIG. 3 is a flowchart of a method for adaptive media processing command handling.

FIG. 4 is a diagram illustrating an example performance of blocks 305 and 310 of the method of FIG. 3.

FIG. 5A is a diagram illustrating an example performance of block 330 of the method of FIG. 3.

FIG. 5B is a diagram illustrating another example performance of block 330 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a media processing device, the method including: determining an attribute of a radiofrequency (RF) tag associated with a media supply; receiving a command to write first data to the RF tag; determining whether the first data and the RF tag are compatible based on the attribute; when the first data and the RF tag are incompatible, modifying the first data to generate modified data compatible with the RF tag based on the attribute; and writing the modified data to the RF tag.

Additional examples disclosed herein are directed to a device, including: a housing; a printhead disposed in the housing, the printhead being configured to print on a media supply; a radiofrequency (RF) transcoder disposed in the housing; and a controller configured to: determine an attribute of a radiofrequency (RF) tag associated with the media supply; receive a command to write first data to the RF tag; determining whether the first data and the RF tag are compatible based on the attribute; when the first data and the RF tag are incompatible, modifying the first data to generate modified data compatible with the RF tag based on the attribute; and control the RF transcoder to write the modified data to the RF tag.

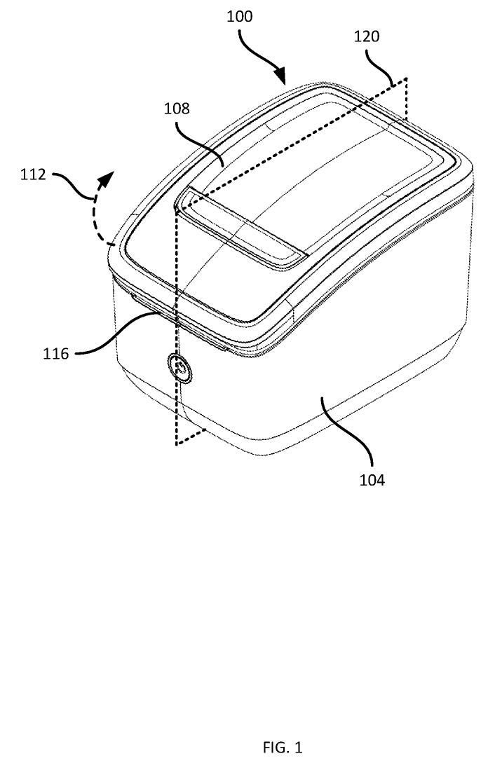

FIG. 1 illustrates an example device in the form of a media processing device 100, such as a label printer (also referred to herein as the printer 100). The printer 100 can be implemented as a desktop printer, as illustrated. The printer 100 can also be implemented in a wide variety of other form factors, including a mobile printer, tabletop or industrial printer, or the like. The printer 100 includes various components configured to apply indicia to media such as discrete labels, a continuous paper strip, identity cards, or the like. The indicia can be applied, for example, by direct thermal printing, thermal transfer printing, or the like. In other examples, the media processing device 100 can include a radio frequency (RF) transcoder (e.g., encoder/reader) assembly configured to read data from RF tags embedded in the labels, write data to RF tags embedded in labels or other media, in addition to or instead of applying indicia to the media.

The printer 100 includes a body 104 housing a media supply, a printhead, and other components, as well as a cover or door 108 configured to open (e.g., in a direction 112) to provide access to an interior of the printer 100. The printer 100 further includes an outlet 116, from which processed media (e.g., labels with indicia having been applied thereto within the body 104 of the printer 100) is dispensed.

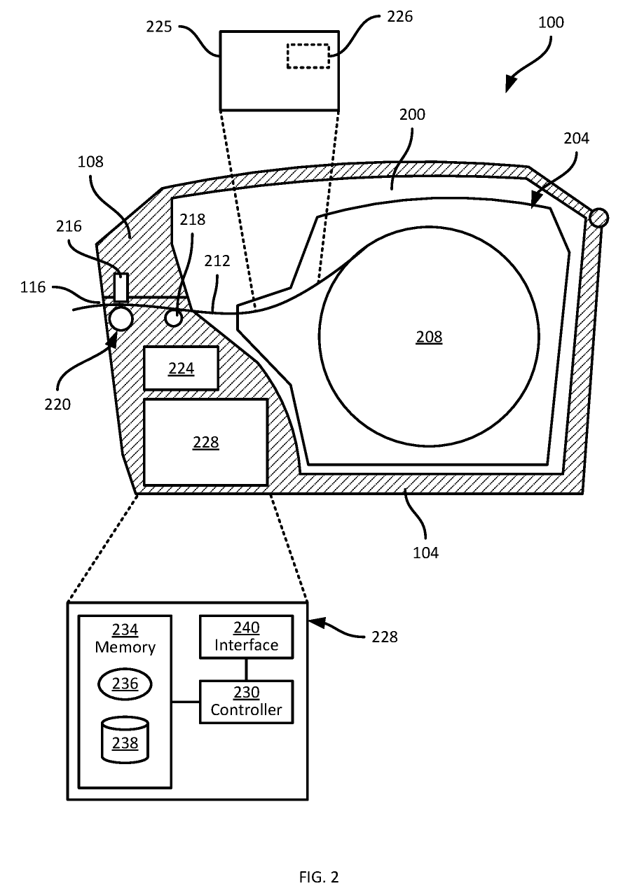

FIG. 2 illustrates a simplified cross sectional view of the printer 100, taken at the plane 120 shown in FIG. 1. As seen in FIG. 2, the body 104 and the cover 108 define a chamber 200 for receiving one or more media supplies, such as a roll 208 of paper, labels, or the like, a media cartridge 204 (also referred to herein as a supply 204) containing a roll 208 of paper, labels, or the like, or other media supplies. In other examples, the media supplies accommodated in the chamber 200 can include boxes of fan-feed labels, identity cards, or the like. In still other examples, the printer 100 can include an inlet in the body 104 for receiving media from an external supply, e.g., to travel through the chamber 200 for processing.

Media 212 from the supply 204 (e.g., from the roll 208, in the illustrated example) travels along a media path from the supply 204 to a nip formed by a printhead 216 and a platen roller 220. The media path can be defined by surfaces, rollers, and the like, such as a guide roller 218 (e.g., a passive, or non-driven, roller). The platen roller 220 can be driven, e.g., to pull the media 212 along the media path and through the nip, where the printhead 216 applies indicia to the media 212. The processed media (e.g., bearing indicia applied by the printhead 216) is then dispensed at the outlet 116. The device 100 also includes an RF transcoder 224, e.g., including one or more antennas and associated controllers, configured to read data from and/or write data to RF tags embedded in the media. For example, the supply 204 can be a roll of labels, an example label 225 of which is shown in FIG. 2 in overhead view, with an embedded RF tag 226.

In some examples, the printhead 216 can be omitted and the device 100 can be configured as an RF reading and/or writing device, e.g., including the RF transcoder 224 and omitting pigment-based printing functionality.

The device 100 further includes a control subsystem 228. As shown in FIG. 2, the control subsystem 228 can include a controller 230 such as a central processing unit (CPU), an application-specific integrated circuit (ASIC), or the like, connected to and/or integrated with a memory 234 storing a plurality of computer-executable instructions. The instructions can include, for example, a control application 236, e.g., implemented as firmware or the like. The memory 234 can also store one or more repositories, such as lookup tables or the like. In this example, the memory 234 stores a repository 238 of RF tag attributes.

The subsystem 228 can also include a communication interface 240, e.g., including one or more antennas and/or data ports and associated control hardware permitting the device 100 to communicate with other computing devices. For example, the device 100 can receive media processing commands from a host computing device (e.g., a desktop computer, a smartphone, server, or the like), including data such as text, images, or the like, to be printed onto media from the supply 204 (e.g., onto a given label). The device 100 can also receive data to be written to an RF tag embedded in the media. For example, the command can include an electronic product identifier (EPC) to be written to the RF tag 226 of a given label 225.

To execute a media processing command, the controller 230 can control the printhead 216 to apply indicia to the media 212, e.g., by activating thermal elements of the printhead 216 to apply heat to corresponding portions of the media 212. As will be apparent to those skilled in the art, for direct thermal printers, as shown in FIG. 2, application of heat to a portion of the media 212 may activate a thermochromic pigment in the media 212. For thermal transfer printers, a pigment-carrying ribbon (not shown) can traverse the nip with the media 212, and application of heat to a portion of the media 212 and the ribbon can cause the transfer of pigment from the ribbon to the media 212.

The controller 230 can further control the RF transcoder 224 to read data from the RF tag 226 and/or write the relevant data from the command to the RF tag 226 of the label 225. Under some conditions, the write operation may fail, e.g., when the data the device 100 attempts to write to the tag 226 is incompatible with the RF tag 226. For example, the tag 226 may have one or more attributes, such as a storage capacity of memory or storage capacity of a section of memory where the storage capacity is smaller than the size of the data contained in the command to be written to the tag 226 causing the write operation to fail. In other examples, the data to be written to the tag 226 may include a first portion to be written to a main memory bank (e.g., an EPC bank) of the tag 226, and a second portion to be written to a secondary memory bank. If the tag 226 does not have such a secondary bank, the write operation may fail.

When the write operation fails, the device 100 may be configured to void the label 225, e.g., printing an error, void indicator, or the like, on the label 225 in addition to or instead of the image, text, or the like, contained in the command and intended for printing to the label 225. The label 225 may therefore be rendered unsuitable for use. Data incompatible with tag attributes may be provided to the device 100, e.g., by a host computing device, under various conditions. For example, the device 100 may accept more than one type of media using more than one type of RF tag, and a host application may generate data that is compatible with some media types and RF tags, but not others. For example, the host application may generate media processing commands that include EPCs for writing to RF tags that are 128 bits long, and are thus incompatible with RF tags 226 having smaller writable storage capacities than 128 bits.

The device 100 is configured to mitigate or avoid the loss of labels (e.g., due to voiding following failed RF write operations) arising from incompatibilities between write data and RF tag attributes, by detecting such incompatibilities and modifying the data to be written to the RF tag 226. For example, the device 100 can be configured to truncate the above-mentioned 128-bit EPC in response to detecting that the labels 225 of the current media supply 204 lack sufficient writable capacity to store the whole EPC. The device 100 can also implement various other modifications to data received in media processing commands, to reduce the number of labels voided while retaining at least some of the functionality of the labels 225 imparted by the modified data written to the tags 225. The actions performed by the device 100 to adaptively modify media processing commands to mitigate RF write failures (and associated label losses, for example) can be implemented via the execution of the application 236 by the controller 230.

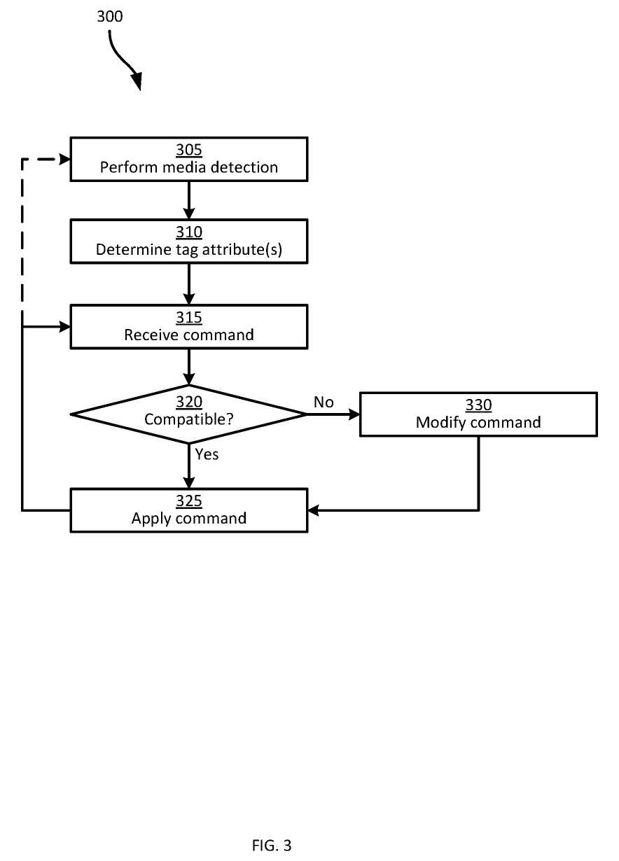

Turning to FIG. 3, a method 300 of adaptive media processing command handling is illustrated. The method 300 will be described in conjunction with its performance in the device 100, and in particular by the controller 230, via execution of the application 236.

At block 305, the device 100 is configured to perform a media detection operation. The media detection operation can be initiated, for example, when the device 100 powers on, and/or when the cover 108 is closed. Media detection can be performed under any circumstances in which a new supply 204 of media may have been placed into the device 100 (even if a new media supply has not been placed into the device, e.g., the lid was opened and closed but the media was not changed). As will be apparent to those skilled in the art, media detection can include a calibration routine in which the device 100 determines dimensions of one or more labels 225 of the supply 204. The calibration routine can also include selecting one or more antennas of the RF transcoder 224 for use in writing data to the RF tags 226, and/or selecting power levels for such transmitters.

In this example, at block 305, e.g., during the media detection operation, the device 100 also reads data stored on one or more RF tags 226 of the supply 204. For example, as a label 225 travels past one or more sensors disposed along the media path, e.g., to determine label dimensions, the device 100 can also activate the RF transcoder 224 to read data from the RF tag 226 embedded in that label 225. The data obtained by the RF transcoder 224 can include tag identifier (TID) data, e.g., stored in a TID memory bank of the RF tag 226. The TID data can include a binary value defining, for example, a serial number for the RF tag 226, a model number for the RF tag 226, and other suitable descriptive information. The TID data may be read-only (e.g., permanently locked), and may be written to the RF tag 226 at the time of manufacturing of the RF tag 226.

At block 310, the device 100 is configured to determine one or more tag attributes, e.g., based on the TID data obtained at block 305. The tag attributes can include at least a writable storage capacity of the tag 226. The writable storage capacity corresponds, in this example, to the capacity of an EPC memory bank of the RF tag 226 (although other portions of the tag may also be writable). In some examples, the tag attributes determined at block 310 include an indication of whether the RF tag 226 has an auxiliary writable memory, e.g., distinct from the EPC memory bank.

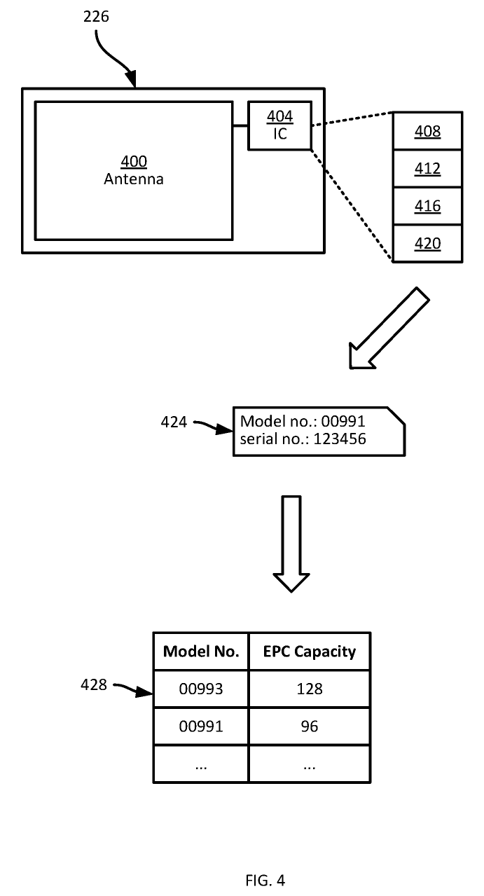

Turning to FIG. 4, example components of the RF tag 226 are shown. The RF tag 226 includes an antenna 400, e.g., a coil of wire, circuit trace, or the like, as well as an integrated circuit 404 that includes one or more memory banks. The memory of the IC 404 can include, as shown in FIG. 4, a TID bank 408 containing the TID data mentioned above. The memory can also include an EPC bank 412, e.g., configured to be written by the RF transcoder 224. The EPC bank 412 may also be referred to as the writable storage of the RF tag 226, in that the EPC bank 412 may be the primary target for data written by the device 100. The memory can also include a reserved bank 416, e.g., storing access data (e.g., passwords) used to deactivate the tag 226, or to lock or unlock the EPC bank or other portions of the memory (though not necessarily the TID bank 408, which may be permanently locked as noted above).

The memory can also include, in some RF tags 226, an auxiliary writable bank 420 that may be referred to as a “user” bank. The auxiliary bank 420 may have a smaller writable capacity than the EPC bank, and may be used for certain application-specific data. Some RF tags 226 lack auxiliary banks 420.

The device 100, at block 305, is configured to read TID data 424 from the TID bank 408, such as a tag serial number and model number, as shown in FIG. 4. At block 310, the device 100 can determine tag attributes, such as a writable storage capacity, from a lookup table 428 (which may be stored in the repository 238). The table 428 can list one or more tag model numbers, and map each model number to a writable storage capacity (shown as “EPC capacity” in FIG. 4), e.g., in bits. The table 428, or a further table in the repository 238, can also map other tag attributes to model numbers, such as the presence or absence of an auxiliary memory bank, the storage capacity of the auxiliary memory bank (if present), and the like.

Returning to FIG. 3, at block 315, the device 100 is configured to receive a command, e.g., from another computing device in communication with the device 100. The command can be referred to as a media processing command or a print command, and includes data to be written to the RF tag 226. The command can also include data to be printed on the label 225. The data to be written to the RF tag 226 can include a string defining an electronic product code, for example.

At block 320, the device 100 is configured to determine whether the data to be written to the RF tag 226 and the attribute(s) from block 310 are compatible. The determination at block 320 can include, for example, determining whether the length (e.g., a number of bits) of the data received at block 315 for writing to the RF tag 226 exceeds the writable storage capacity determined at block 310. In other examples, the determination at block 320 can include determining whether the command from block 315 contains data for writing to an auxiliary memory bank 420, and whether the RF tag 226 has an auxiliary memory bank.

If the size of the string received for writing to the EPC bank 412 does not exceed the storage capacity determined at block 310, the determination at block 320 is affirmative. In examples whether other attributes, such as the presence or absence of an auxiliary bank 420, are considered at block 320, an affirmative determination at block 320 may require each attribute to be compatible with the corresponding portion of the command. For example, if the command includes an EPC string with a length of 128 bits and a string for writing to the auxiliary bank 420, an affirmative determination at block 320 may require the tag attributes from block 310 to indicate both a writable storage capacity of at least 128 bits, and the presence of an auxiliary bank 420.

In response to an affirmative determination at block 320, the device 100 can proceed to block 325 and apply the command from block 315. In other words, the device 100 can execute the command from block 315 without modification, e.g., printing data on the label 225 and writing data to the RF tag 226. Following block 325, the device 100 may return to block 315 to await a further command. Under some conditions, the device 100 may return to block 305, e.g., when a power-on event is detected, when the cover 108 closes, or the like.

If the size of the string received for writing to the EPC bank 412 exceeds the storage capacity determined at block 310, or if any other tag attribute determined at block 310 is not compatible with the command from block 315, the determination at block 320 is negative. When the determination at block 320 is negative, the device 100 proceeds to block 330. At block 330, the device 100 is configured to modify the command from block 315. The modification(s) applied at block 330 generate modified data for writing to the tag 226 that is compatible with the tag attributes from block 310.

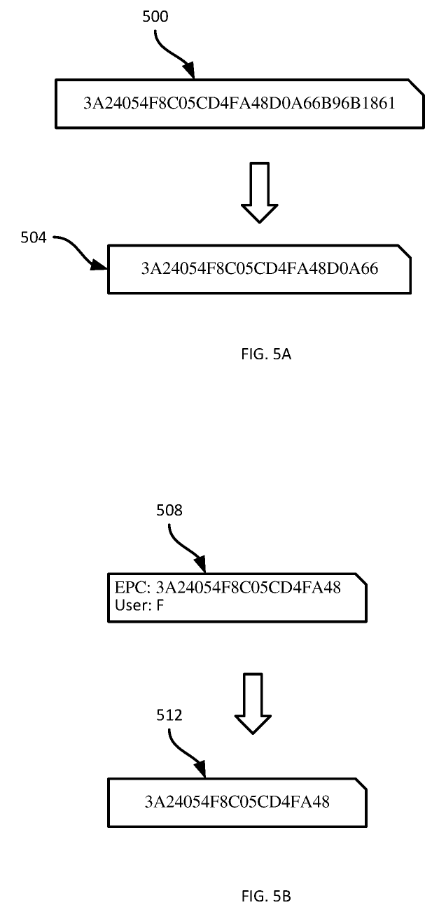

In some examples, as shown in FIG. 5A, the modification applied at block 330 is to truncate the data from the original command. FIG. 5A illustrates a command 500 containing a 128-bit (shown in hexadecimal) string to be written to the RF tag 226. In response to determining that the length of the data in the command 500 exceeds the writable storage capacity of the RF tag 226 (e.g., 96 bits), the device 100 generates a modified command 504 containing modified data from which the least-significant 32 bits (that is, the right-most eight hexadecimal digits) have been truncated.

FIG. 5B shows another example performance of block 330, in which a command 508 includes a 76-bit EPC value for writing to the EPC bank 412 of the RF tag 226, and a four-bit value for writing to the auxiliary bank 420 of the RF tag 226. The tag attributes determined at block 310 may indicate that the RF tag 226 does not include an auxiliary bank 420, and the device 100 may therefore generate a modified command 512 that includes the 76-bit value from the original command, but omits the value intended for an auxiliary memory bank 420.

In some examples, the modifications implemented at block 330 can include inserting data in the modified commands. For example, the device 100 can be configured, when truncating an original value, to append a flag (e.g., a predetermined value of any suitable length) indicating that the data has been truncated. For example, the device 100 can be configured to truncate an additional eight bits beyond the amount truncated to fit within the writable storage capacity of the RF tag 226, and append an eight-bit flag to the value.

In further examples, the command received at block 315 can include alternative values, e.g., for the EPC bank 412. The command may include, for example, an EPC according to a first syntax and with a first length, and an EPC according to a second format with a second length. The device 100 can be configured to select either the first or second EPC for writing to the tag 226, e.g., by selecting the largest EPC that is compatible with the writable storage capacity of the tag 226.

By modifying data to be written to the RF tags 226, the device 100 may reduce the incidence of label processing failures (e.g., resulting in voided labels), while retaining at least a portion of the original data from the command at block 315.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a media processing device, the method comprising:
determining an attribute of a radiofrequency (RF) tag associated with a media supply;
receiving a command to write first data to the RF tag;
determining whether the first data and the RF tag are compatible based on the attribute;
when the first data and the RF tag are incompatible, modifying the first data to generate modified data compatible with the RF tag based on the attribute; and
writing the modified data to the RF tag.

2. The method of claim 1, further comprising:
detecting a supply of media including the RF tag; and
reading the RF tag.

3. The method of claim 1, wherein the attribute of the RF tag is a writable storage capacity of the RF tag and the first data is incompatible with the RF tag because the first data exceeds the writable storage capacity.

4. The method of claim 3, wherein the writable storage capacity is a capacity of an electronic product code (EPC) memory bank of the RF tag.

5. The method of claim 3, wherein modifying the first data includes truncating the first data.

6. The method of claim 1, wherein determining the attribute includes reading a tag identifier (TID) memory bank of the RF tag.

7. The method of claim 1, wherein determining the attribute includes:
reading a model number from the TID memory bank; and
determining the attribute based on the model number.

8. The method of claim 7, further comprising:
storing a mapping between the model number and the attribute; and
wherein determining the attribute includes retrieving the attribute from the mapping based on the model number.

9. A device, comprising:
a housing;
a printhead disposed in the housing, the printhead being configured to print on a media supply;
a radiofrequency (RF) transcoder disposed in the housing; and
a controller configured to:
determine an attribute of a radiofrequency (RF) tag associated with the media supply;
receive a command to write first data to the RF tag;
determining whether the first data and the RF tag are compatible based on the attribute;
when the first data and the RF tag are incompatible, modifying the first data to generate modified data compatible with the RF tag based on the attribute; and
control the RF transcoder to write the modified data to the RF tag.

10. The device of claim 9, wherein the controller is further configured to:
detect a supply of media including the RF tag; and
read the RF tag.

11. The device of claim 9, wherein the attribute of the RF tag is a writable storage capacity of the RF tag.

12. The device of claim 11, wherein the writable storage capacity is a capacity of an electronic product code (EPC) memory bank of the RF tag.

13. The device of claim 11, wherein the controller is configured to modify the first data by truncating the first data.

14. The device of claim 9, wherein the controller is configured to determine the attribute by reading a tag identifier (TID) memory bank of the RF tag.

15. The device of claim 9, wherein the controller is configured to determine the attribute by:
reading a model number from the TID memory bank; and
determining the attribute based on the model number.

16. The device of claim 15, wherein the controller is configured to:
store a mapping between the model number and the attribute; and
determine the attribute by retrieving the attribute from the mapping based on the model number.
